(19) United States
(12) Patent Application Publication
(10) Pub. No.: US 2007/0253058 A1
(43) Pub. Date: Nov. 1, 2007

(54) Brightness enhancement structures including optical microstructures to provide elliptical diffusion patterns and methods of fabricating and operating the same

(75) Inventor: Robert L. Wood, Apex, NC (US)

Correspondence Address: MYERS BIGEL SIBLEY & SAJOVEC, PO BOX 37428, RALEIGH, NC, 27627, US

(73) Assignee: Bright View Technologies, Inc.

(21) Appl. No.: 11/414,875

(22) Filed: May 1, 2006

(51) Int. Cl. G03B 21/60

(52) U.S. Cl. 359/455

(57) ABSTRACT

A brightness enhancement structure includes a substrate having first and second opposing sides. An array of optical microstructures is located on the first side of the substrate and a cladding layer is located on the array of optical microstructures opposite the substrate. Fresnel microstructures are located on the second side of the substrate. Related methods of forming and operating are also disclosed.

### BACKGROUND

It is known to use optical diffusers in display applications to diffuse light to provide specific patterns of light diffusion. For example, ground glass can produce a circularly symmetric light diffusion pattern, whereas a lenticular diffusion screen can produce a substantially one-dimensional pattern. In particular, a lenticular diffusion screen can include an array of cylindrically shaped lenses oriented so that the long axes are parallel to one another to provide an optical diffusion pattern that is substantially one-dimensional in the direction of the long axes (e.g., height) with a width that is determined by the shape of the cylindrical lenses.

It is also known to provide a light diffusion pattern that is a combination of the circular and one-dimensional patterns discussed above. For example, some diffusers may provide an elliptical light diffusion pattern having mutually orthogonal major and minor axes. Elliptical light pattern diffusers can be used in either transmission based (i.e. rear projection) or reflection based (i.e. front projection) screens to provide elliptical light diffusion patterns that are wider in a horizontal direction than in a vertical direction.

Rear projection screens utilizing lenticular lenses may include more than one diffuser. For example, it is known to use a lenticular diffusion screen that provides one-dimensional diffusion in a horizontal direction with other diffusers to provide diffusion in a vertical direction. Furthermore, some diffusers may be used to reduce imaging artifacts such as speckle, moiré, and ghosting. Such diffusers are discussed in, for example, U.S. Pat. Nos. 5,513,036; 5,999,281; 6,307,675; 5,066,099; 4,762,393; 6,940,643; 6,502,952 and 6,400,504.

Some conventional screens utilize a Fresnel lens to collimate light that is provided to a lenticular screen that includes an optical blocking layer to provide contrast. The Fresnel lens can be a microstructure on a surface of a transparent base, which may have a diffusive material incorporated therein to address the speckle, moiré and ghosting effects discussed above. Another approach to reducing these imaging artifacts is to texture the opposing surface of the transparent base (i.e. surface of the base opposite the Fresnel microstructures).

One of the drawbacks associated with the use of additional diffusers discussed above is that some of light provided by the image source may not be transmitted from the screen. In particular, some of the light impinging on the lenticular screen (that includes the optical blocking layer) can be off-axis to such a degree that the off-axis light is refracted into and absorbed by the optical blocking layer. The light that impinges on the optical blocking layer may, therefore, not be transmitted from the screen, which may reduce the overall brightness of the screen.

As shown in FIG. 1, on-axis light 100 is refracted by a lenticular lens to provide refracted light 110, which passes through an aperture 130 in an optical blocking layer 115 to be transmitted from a screen. However, off-axis light 120 is refracted to provide refracted light 125 that impinges on the optical blocking layer 115 rather than passing through the aperture 130, and being transmitted from the screen. Therefore, the screen may have a reduced brightness due to the off-axis light 120 being blocked by the optical blocking layer 115 rather than being transmitted from the screen.

Rear projection lenticular screens are available from, for example, Toppan Printing Co., Ltd. (Japan).

### SUMMARY

Embodiments according to the invention can provide brightness enhancement structures including optical microstructures to provide elliptical diffusion patterns and methods of fabricating and operating the same. Pursuant to these embodiments, a brightness enhancement structure includes a substrate having first and second opposing sides. An array of optical microstructures is located on the first side of the substrate and a cladding layer is located on the array of optical microstructures opposite the substrate. Fresnel microstructures are located on the second side of the substrate.

In some embodiments according to the invention, a rear-projection screen includes a brightness enhancement structure that is configured to provide an elliptical light diffusion pattern with a major axis in a first screen dimension and a minor axis in a second screen dimension, that is orthogonal to the first screen dimension, to provide for transmission of light from the screen comprising a distribution pattern where a full-width-at-half maximum (FWHM) of the distribution pattern is located at +/− about 2 to about 30 degrees in the first screen dimension.

In some embodiments according to the invention, a brightness enhancement structure includes an array of compound microlenses including a first portion having a first index of refraction and a second portion, upstream from the first portion, having a second index of refraction at an interface with the first portion.

In some embodiments according to the invention, a brightness enhancement structure includes a lens weakening layer located on an array of optical microlenses, where the lens weakening layer is configured to provide a divergence angle of light from the structure that is less than the array of optical microlenses alone.

In some embodiments according to the invention, a brightness enhancement structure includes an array of compound microlenses having two separate refractive indexes, the array being located on a first side of a substrate and Fresnel microlenses being located on a second side of the substrate opposite the array of compound micro lenses.

In some embodiments according to the invention, a rear-projection screen includes a brightness enhancement structure including a substrate that is configured for placement downstream from a light source and having a first side facing upstream and a second side facing downstream. An array of first lenticular lenses is on the first side of the substrate and is oriented in a first dimension of the screen. A cladding layer is on the array of first lenticular lenses and an array of fresnel microstructures is on the second side of the substrate opposite the array of first lenticular lenses. An array of second lenticular lenses is orthogonal to the first lenticular lenses downstream from the brightness enhancement structure.

In some embodiments according to the invention, a method of fabricating a brightness enhancement film for a rear-projection screen includes forming an array of optical microstructures on a first side of a substrate. A cladding material is flowed between the array of optical microstructures and a planar sheet of polyester opposite the substrate. The cladding material is cured and Fresnel microstructures are formed on a second side of the substrate opposite the first side.

In some embodiments according to the invention, a method of operating a rear-projection screen includes receiving light from a light source and refracting the received light in a first screen dimension according to a first refractive index to provide first refracted light. The first refracted light is refracted in the first screen dimension according to a second refractive index to provide second refracted light. The second refracted light is refracted to provide an elliptical diffusion pattern with a major axis in the first screen dimension and the second refracted light is refracted in the elliptical diffusion pattern to provides for transmission of light from the screen according to a distribution pattern where a full-width-at-half maximum (FWHM) of the distribution pattern is located at +/− about 2 to about 30 degrees in the first screen dimension.

### BRIEF DESCRIPTION OF THE DRAWINGS

FIG. 1 is a cross-sectional view that illustrates a conventional lenticular micro lens having a portion of off-axis light incident thereon blocked from transmission.

FIG. 2 is a perspective view that illustrates brightness enhancement structures included in screens according to some embodiments of the invention.

FIG. 3A is a cross-sectional view that illustrates brightness enhancement structures according to some embodiments of the invention

FIG. 3B is a cross-sectional view that illustrates brightness enhancement structures including cladding layers with diffusion materials therein according to some embodiments of the invention.

FIG. 3C is a cross-sectional enlarged view that illustrates a compound microlens according to some embodiments of the invention

FIG. 4 is a graph illustrating an exemplary Gaussian distribution of light in a vertical dimension that is provided as part of an elliptical diffusion pattern from a screen with a Full Width at Half Maximum (FWHM) at +/−15-20 degrees measured from on-axis according to some embodiments of the invention.

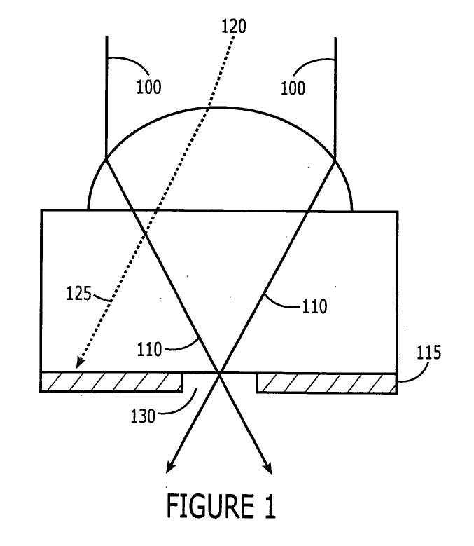

### DESCRIPTION OF EMBODIMENTS ACCORDING TO THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thickness of layers and regions may be exaggerated for clarity. Like numbers refer to like elements throughout. As used herein the term “and/or” includes any and all combinations of one or more of the associated listed items and may be abbreviated as “/”.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “having,” “having,” “includes,” and/or “including” when used in this specification, specify the presence of stated features, regions, steps, operations, elements, and/or components, but do not preclude the presence or addition of one or more other features, regions, steps, operations, elements, components, and/or groups thereof.

It will be understood that when an element such as a layer or region is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Finally, when light is referred to as “directly passing,” it means that a reflector-free path is provided.

It will be understood that, although the terms first, second, etc. may be used herein to describe various elements, components, regions, layers and/or sections, these elements, materials, regions, layers and/or sections should not be limited by these terms. These terms are only used to distinguish one element, material, region, layer or section from another element, material, region, layer or section. Thus, a first element, material, region, layer or section discussed below could be termed a second element, material, region, layer or section without departing from the teachings of the present invention. Moreover, the terms “front” and “back” may be used herein to describe opposing outward faces of a display screen. Conventionally, the viewing face is deemed the front, but the viewing face may also be deemed the back, depending on orientation. The terms “horizontal” and “vertical” indicate specific orientations based upon the ultimate orientation of the direct-view display. The terms “upstream” and “downstream” are sometimes used herein to describe relative locations of elements in an optical apparatus in reference to the transmission of light from a source to a viewer. For example, when a first element is referred to as being “upstream” from a second element, the first element receives light from the light source before the second element. Further, the second element can be described as being “downstream” from the first element as the second element receives the light after the first element.

Embodiments of the present invention are described herein with reference to illustrations that are schematic illustrations of idealized embodiments according to the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated, typically, may be rounded. Thus, the regions illustrated in the figures are schematic in nature and their shapes are not intended to illustrate the precise shape of a region and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although the term “arrays” is used herein to describe arrangements of various microstructures (such as optical microstructures), it will be understood that “arrays” of microstructures can refer to less than all of the microstructures on the screen. Moreover, arrays can include microstructures that are different from one another or are the same but oriented differently.

As described hereinbelow in greater detail, embodiments according to the invention can provide brightness enhancement structures that can refract light within an acceptance angle of a lenticular lens in a dimension that is orthogonal to the major axis of the lenticular lens. Accordingly, the refracted light diverges from the structure, but only to the extent that it stays within the acceptance angle of the lenticular lens. For example, in some embodiments according to the invention the lenticular lens has a much lower acceptance angle in a horizontal dimension than in a vertical dimension. Accordingly, the brightness enhancement structure can be configured to allow only limited divergence in the horizontal dimension and more divergence in the vertical dimension.

For example, in some of the embodiments according to the invention, the brightness enhancement structure can provide an elliptical diffusion pattern by refracting light so that light transmitted from the screen is provided at a divergence angle that is in a range of about +/−2 to 30 degrees in a vertical dimension of the screen. Moreover, a divergence angle for the pattern in the horizontal dimension may be less than the divergence angle in the vertical dimension of the screen. The brightness enhancement structures, according to some embodiments of the invention, can increase brightness by concentrating more light provided by the image source into a zone defined by the divergence angle, which may increase the brightness of an image perceived by a viewer.

In further embodiments according to the invention, a brightness enhancement structure includes an array of optical microstructures having a first index of refraction and a cladding layer formed thereon that has a second index of refraction that is different than the first index of refraction. For example, in some embodiments according to the invention, the first index of refraction of the array of optical microstructures is about 1.5 whereas the index of refraction of the cladding layer is about 1.4. In some embodiments according to the invention, the respective indices are reversed.

The combination of cladding and optical microstructure, with their respective different refractive indices, causes upstream light impinging thereon to be refracted into a divergence angle that is determined by the shape of the optical microstructure, its refractive index, and the refractive index of the cladding. Accordingly, the combination of the array of optical microstructures and cladding layer can operate as compound microlenses having two different refractive indices.

In further embodiments according to the invention, the cladding layer can include a diffusion material to diffuse the upstream light impinging thereon to reduce the moiré, speckle, and ghosting imaging artifacts. In some embodiments according to the invention, Fresnel microstructures are located on an opposing side of the substrate. Furthermore, the inclusion of the diffusion material in the cladding layer may enable the Fresnel microstructures to be fabricated on an opposing side of the substrate on which the optical microstructures are fabricated. Inclusion of the diffusion material in the cladding layer may therefore enable the array of optical microstructures and Fresnel microstructures to be closely located to each other, such as about 5.0 mm or less to avoid a relatively large gap between the array of optical microstructures and Fresnel microstructures.

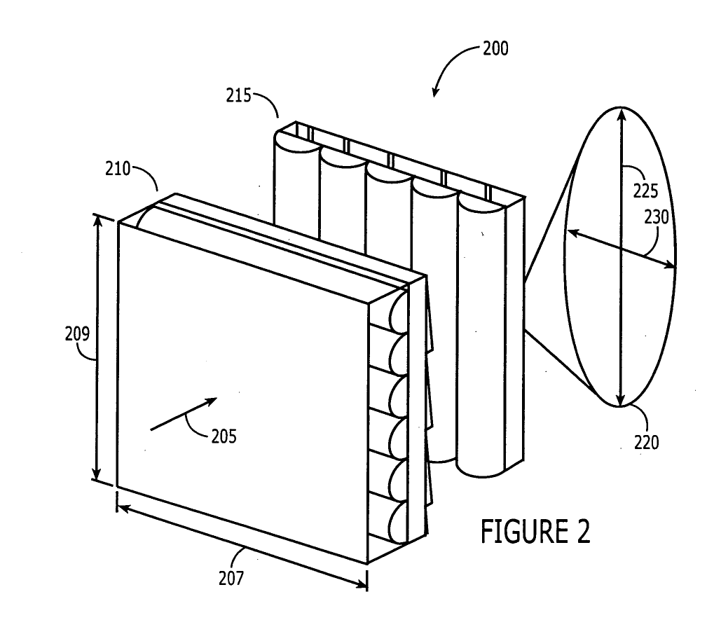

Various embodiments of the invention will now be illustrated with respect to FIGS. 2-4. These embodiments shall be regarded as merely illustrative and shall not be construed as limiting the invention. Moreover, the embodiments described and illustrated herein may be combined in various combinations and subcombinations.

FIG. 2 is a perspective view of a rear-projection screen 200 including a brightness enhancement structure 210 according to some embodiments of the invention. As shown in FIG. 2, the brightness enhancement structure 210 is positioned downstream from an image source (not shown) so that light 205 impinges thereon. The brightness enhancement structure 210 is located upstream from lenticular lenses 215 which refract light provided by the brightness enhancement structure for transmission from the screen 200 towards a viewer. Cylindrically-shaped microstructures constitute the lenticular lenses 215 that are in registration with corresponding apertures formed in an optical blocking layer so that light that does not pass through one of the apertures is blocked from transmission.

The brightness enhancement structure 210 includes an array of optical microstructures that are cylindrical in shape having a major axis in a first dimension 207 of the screen 200. In contrast, the cylindrically shaped microstructures in the lenses 215 have major axes in a second dimension 209 of the screen 200 that is orthogonal to the first dimension 207. Although the optical microstructures included in the brightness enhancement structure 210 are oriented in the horizontal dimension of the screen 200 and the cylindrical lenses included in the lenticular lens 215 are oriented in a vertical dimension of the screen 200, it will be understood that the respective orientations of the brightness enhancement structure 210 and the lenticular lenses 215 can be reversed.

The optical microstructures in the brightness enhancement structure 210 are positioned on a first side of a transparent substrate and have a cladding layer thereon that faces upstream (toward the image source). The brightness enhancement structure 210 can also include Fresnel microstructures on a second side of the transparent substrate (opposite the optical microstructures) that face upstream towards the lenticular lenses 215.

In operation, the light 205 is provided by the image source to impinge on the cladding layer of the brightness enhancement structure 210. The light 205 is refracted by the brightness enhancement structure 210 to provide first refracted light according to the mismatched refractive indices of the cladding layer and the array of optical microstructures. The first refracted light is provided through the Fresnel microstructures in an elliptical diffusion pattern having a major axis in the vertical dimension 209 of the screen 200 and a minor axis in the horizontal dimension 207 of the screen 200.

The lenticular lenses 215 refract the first refracted light to provide second refracted light from the screen 200 in an elliptical diffusion pattern 220. The elliptical diffusion pattern 220 has a major axis 225 in the vertical dimension 209 of the screen 200 and a minor axis 230 in the horizontal dimension 207. Accordingly, the brightness enhancement structure 210 is configured to refract the light 205 so that the elliptical diffusion pattern concentrates an increased amount of light parallel to the major axis of the lenticular lenses 215. Therefore, when the first refracted light impinges on the lenticular lenses 215, less light may be clipped by the apertures included therein because more of the light has been concentrated in the vertical dimension of the screen by the brightness enhancement structure 210.

The brightness enhancement structure 210 can provide the first refracted light within an acceptance angle of the lenticular lenses 215 in a dimension that is orthogonal to the major axis of the lenticular lenses 215. In other words, the first refracted light diverges from the structure 210, but only to the extent that it stays within the acceptance angle of the lenticular lenses 215. The acceptance angle is defined as the angle beyond which light provided to the lenticular lenses 215 would be clipped by the apertures therein. For example, in some embodiments according to the invention the lenticular lenses 215 have a much lower acceptance angle in a horizontal dimension than in a vertical dimension. Accordingly, the brightness enhancement structure 210 is configured to allow only limited divergence in the horizontal dimension and more divergence in the vertical dimension.

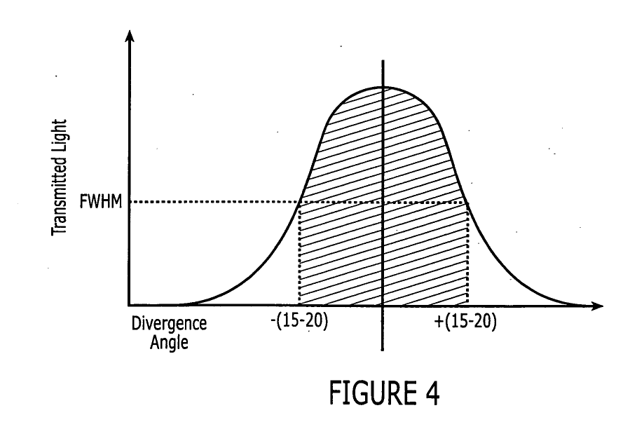

As a result, in some exemplary embodiments according to the invention, viewers located about +/−15-20 degrees measured from on-axis of the screen perceive the Full Width at Half Maximum (FWHM) of the transmitted light as illustrated in FIG. 4. Accordingly, brightness enhancement structures 210 according to some embodiments of the invention can help provide increased brightness compared to conventional screens as less light may be refracted to the extent that clipping by the apertures would occur (i.e. less clipping by the apertures as the light in the dimension orthogonal to the major axis of the lenticular lenses 215 is refracted less so that it falls within the acceptance angle).

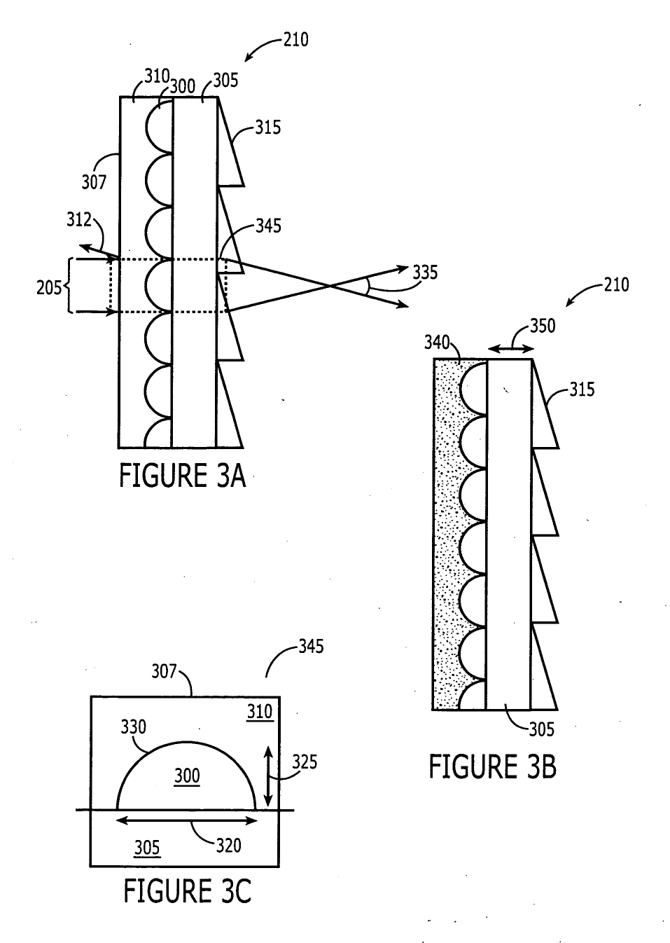

The optical microstructures described herein and as illustrated in, for example, FIGS. 2-3C may be formed by microreplicating a layer including an array of cylindrical or lenticular lens-like projections on one side of a polyester base substrate. The lens-like projections may be replicated from a master using a photopolymer with cured refractive index of about 1.50. Lens-like projections may be fabricated as described in published U.S. Patent Application Nos. 2005/0058947; 2005/0058948; 2005/0058949 and/or 2003/00206342; and/or U.S. Pat. Nos. 6,967,779; 6,788,460; 6,829,087 and/or 6,816,306, the disclosures of which are hereby incorporated herein by reference in their entireties as if set forth fully herein. The optical microstructures need not be limited to lens-like projections, but may also take many other forms such as prisms and complex polyhedra as well as combinations of shapes. Other techniques and materials may be used for replicating the microstructures. Some of these include injection molding, embossing, calendaring, thermoplastic and thermoset resins, and room temperature vulcanizing one-part and two-part systems.

The optical microstructures may be any shape, size, or configuration that causes light impinging thereon from a predefined direction to converge or diverge in a prescribed manner beyond the optical microstructures. The size of the optical microstructures may be small enough such that individual structures are smaller than the size of individual image pixels projected from the image source. The shape of the optical microstructures may be constant and/or may vary across the surface of the screen, and may be lenticular, spherical, aspherical, anamorphic, prism-shaped, pyramidal shape, combinations and subcombinations thereof and/or other shapes. In some embodiments according to the invention, at least one dimension of the optical microstructures is less than 100 μm.

FIG. 3A is a cross sectional view that illustrates brightness enhancement structure 210 according to some embodiments of the invention. As shown in FIG. 3A, an array of optical microstructures 300 is located on a first side of a transparent substrate 305, the optical microstructures 300 having a first index of refraction N1. A cladding layer 310 is formed on the array of optical microstructures 300 to have a second index of refraction, N2, that is different than N1 thereby creating a mis-match in the refractive indices of the optical microstructures 300 and the cladding layer 310. Fresnel microstructures 315 are formed on a second side of the transparent substrate 305 opposite the array of optical microstructures 300. In some embodiments according to the invention, the refractive index of the array of optical microstructures 300 is about 1.5 and the refractive index of cladding layer 310 is about 1.4.

In some embodiments according to the invention, transparent substrate 305 is a polyester based material, a polycarbonate film, acrylic film, acetate film and/or glass, among others. In some embodiments according to the invention, the cladding layer 310 is a room temperature vulcanizing silicone that is free of a diffusion material, which would otherwise promote the diffusion of the light 205 impinged thereon. In some embodiments according to the invention, the cladding layer 310 can be a first photo-polymer based material such as a siloxane-containing polymer, a fluoropolymer or perfluoroacrylate polymer, a siloxane-containing fluoropolymer, a siloxane-containing perfluoroacrylate polymer and/or a siloxane-containing copolymer having a refractive index of about 1.4 or less. In some embodiments according to the invention, the Fresnel lenses 315 are a second photo-polymer based material that is different than the first photo-polymer based material.

The cladding layer 310 can be formed by flowing a room temperature-vulcanizing silicone composition between the optical microstructures 300 and a planar sheet of polyester having a thickness of about 175 μm followed by curing at room temperature. Other cladding materials that may be used include lower refractive index materials such as various siloxane-containing polymers and fluoro- and perfluoroacrylate polymers and/or copolymers.

The combination of the cladding layer 310 and the optical microstructures 300 is such that the light 205 that impinges thereon is refracted to provide refracted light at a divergence angle 335 from the brightness enhancement structure 210. It will be understood that the divergence angle 335 is less than the angle of divergence that would be formed by light refracted through the array of optical microstructures 300 alone. In other words, the cladding layer 310 having a lower index of refraction than the optical microstructures 300 can operate as a lens-weakening layer so that the focal length of the optical microstructures (i.e., microlenses) 300 is effectively lengthened thereby promoting the elliptical diffusion pattern with a divergence angle in a range of about +/−2 to about 30 degrees measured from on-axis of the screen 200 (i.e., relative to a normal direction from the screen 200).

It will be understood that a reflected portion 312 of the light 205 impinging on the cladding layer 310 can be reflected therefrom according to the different refractive indices of the media through which the light 205 is transmitted and that of the cladding layer. In particular, for light arriving at normal incidence, the reflected portion can be given by:
(Nₜₘ−N_{clad})²/(Nₜₘ+N_{clad})²
where Nₜₘ is the refractive index of the transmission media of the light 205 and N_{clad} is the refractive index of the cladding layer 310.

The Fresnel microstructures tend to collimate the light provided thereto. It will be understood that the Fresnel microstructures may include any at least partially non-absorptive layer that causes deviation of light from its original path and may have an index of refraction of about 1.5. Structures that can produce this deviation may include lenses, prisms, gratings, holograms and/or other optical structures. These structures may be produced, for example, using published application numbers US 2005/0058947 A1, U.S. 2005/0058948 A1 and/or US 2005/0058949 A1, cited above, and/or using other techniques. For example, the Fresnel microstructures may be prism-shaped projections in a circular arrangement on the surface of the substrate 305.

FIG. 3B is a cross-sectional view that illustrates brightness enhancement structures 210 including cladding layers 310 having a diffusion material 340 incorporated therein according to some embodiments of the invention. According to FIG. 3B, a diffusion material 340 is included within the cladding layer 310. The diffusion material 340 can help reduce imaging artifacts such as speckle, moiré patterns, and/or ghosting. In some embodiments according to the invention, the diffusion material 340 can be silica, alumina, and/or polymeric material. having a particle size of about 50 microns or less. The diffusion material 340 can be introduced when the cladding layer is being formed.

In still other embodiments according to the invention illustrated by FIG. 3B, the transparent substrate 305 can be relatively thin, thereby reducing a separation distance 350 between the optical microstructures 300 and the Fresnel microstructures 315. In particular, the inclusion of the diffusion material 340 in the cladding layer 310 to address the imaging artifacts described above may enable the transparent substrate 305 to be thinner than a conventional arrangement while still addressing the negative imaging artifacts. Making the transparent substrate 305 thinner may further reduce the cost of the brightness enhancement structure 210 by reducing the amount of material used to provide the transparent substrate 305.

FIG. 3C is an enlarged view of region 345 show in FIG. 3A illustrating a portion of the array of optical microstructures 300 and cladding layer 310 thereon. In particular, the cladding layer 310 on the optical microstructure 300 functions as a lens weakening layer so that the combination of theses two elements (the cladding layer 310 and the optical microstructures 300) operates as a compound microlens having two portions, each with a different refractive index.

In particular, the compound microlens illustrated in FIG. 3C include a first portion corresponding to the optical microstructure 300 having the first refractive index N1 and a second portion corresponding to the cladding layer 300 having the second lower refractive index N2. Moreover, the first and second portions of the compound microlens meet at an interface 330 therebetween where the portions having the mis-matched refractive indices meet. For example, in some embodiments according to the invention, the first portion of the compound microlens has an index of refraction of about 1.5 at the interface 330 whereas the second portion of the compound microlens has lower refractive index of about 1.4 at the interface 330. The compound microlens arrangement of the cladding layer 310 and the optical microstructure 300 operates to refract light at the divergence angle 335.

In further embodiments according to the invention, the refractive index of the second portion 310 of the compound microlens is substantially uniform throughout a thickness thereof. For example, as described above, the second portion 310 of the compound microlens can have a refractive index of about 1.4 exhibited in all portions of the portion from the interface 330 to a surface 307 of the cladding layer 310 that faces upstream towards the image source.

As further shown in FIG. 3C, the optical microstructure 300 can have a substantially hemispherical shape with a height of about 100 μm or less and a width of about 100 μm or less at a base thereof where the optical microstructure 300 contacts the substrate 305.

According to FIG. 4, brightness enhancement structures in some embodiments according to the invention can provide more than about one half of the perceived light in an elliptical diffusion pattern defined by a divergence angle in a range between about +/−2 to about 30 degrees in a dimension of a screen that is parallel to a major axis of lenticular lenses included therein. FIG. 4 shows an exemplary Gaussian distribution curve where about one half of the perceived light is provided to a viewer positioned at +/−15 to 20 degrees (divergence angle) from on-axis. It will be understood that brightness enhancement structures in some embodiments according to the invention, may provide the light in a distribution pattern other than a Gaussian distribution pattern. In contrast, light output from a conventional Toppan screen Model 05SN50W was measured for on-axis optical transmission. It was measured that the Toppan screen provided for transmission of only about 65% of the light provided thereto by image source. In contrast, the same image source was provided to a screen including a brightness enhancement structure according to some embodiments of the invention and was measured to transmit more than 65% and, in some embodiments according to the invention, 80% of the light impinged thereon by the image source at the divergence angle.

As described herein, embodiments according to the invention can provide brightness enhancement structures that can refract light within an acceptance angle of a lenticular lens in a dimension that is orthogonal to the major axis of the lenticular lens. In other words, the refracted light diverges from the structure, but only to the extent that it stays within the acceptance angle of the lenticular lens. For example, in some embodiments according to the invention the lenticular lens has a much lower acceptance angle in a horizontal dimension than in a vertical dimension. Accordingly, the brightness enhancement structure can be configured to allow only limited divergence in the horizontal dimension and more divergence in the vertical dimension.

In some of the embodiments according to the invention, the brightness enhancement structure can provide an elliptical diffusion pattern by refracting light at a divergence angle that is a range of about +/−2 to about 30 degrees in a vertical dimension of the screen. The brightness enhancement structures, according to embodiments of the invention, can increase brightness by concentrating more light provided by the image source into a zone defined by the divergence angle, thereby increasing the brightness of an image perceived by a viewer.

In the drawings and specification, there have been disclosed embodiments of the invention and, although specific terms are employed, they are used in a generic and descriptive sense only and not for purposes of limitation, the scope of the invention being set forth in the following claims.

What is claimed:

1. A brightness enhancement structure comprising:
a substrate having first and second opposing sides;
an array of optical microstructures on the first side of the substrate;
a cladding layer on the array of optical microstructures opposite the substrate; and
fresnel microstructures on the second side of the substrate.

2. A brightness enhancement structure according to claim 1 wherein the optical microstructures have a first index of refraction and the cladding layer has a second index of refraction at an interface thereof with the optical microstructures that is different than the first index of refraction.

3. A brightness enhancement structure according to claim 2 wherein the first index of refraction is about 1.5 or 1.4 and the second index of refraction is about 1.5 or 1.4 or less so that the first and second indices of refraction are unequal.

4. A brightness enhancement structure according to claim 1 wherein the cladding layer has a substantially constant index of refraction throughout a thickness thereof.

5. A brightness enhancement structure according to claim 1 wherein the cladding layer includes a diffusion material configured to diffuse light impinging thereon to provide diffused light to the array of optical microstructures.

6. A brightness enhancement structure according to claim 1 wherein the cladding layer is free of a diffusion material.

7. A brightness enhancement structure according to claim 1 wherein the fresnel microstructures comprise a photopolymer based material.

8. A brightness enhancement structure according to claim 7 wherein the photopolymer based material comprises a first photo-polymer based material; and
wherein the cladding layer comprises a second photo-polymer based material that is different than the first photo-polymer based material.

9. A brightness enhancement structure according to claim 8 wherein the substrate comprises a polyester based material.

10. A brightness enhancement structure according to claim 1 included in a rear-projection screen, wherein the array of optical microstructures comprises an array of lenticular lenses oriented in a first dimension of the screen; and
wherein the screen further comprises an array of lenticular lenses oriented in a second dimension of the screen that is orthogonal to the first dimension.

11. A brightness enhancement structure according to claim 1 included in a rear-projection screen, wherein the array of optical microstructures comprises an array of horizontal lenticular lenses oriented in a horizontal dimension of the screen; and
wherein the screen further comprises an array of vertical lenticular lenses oriented in a vertical dimension of the screen downstream from the array of horizontal lenticular lenses.

12. A brightness enhancement structure according to claim 1 wherein the optical microstructures comprise a maximum height of about 100 microns.

13. A brightness enhancement structure according to claim 12 wherein the optical microstructures comprise a width of about 100 microns or less at a base thereof at the substrate.

14. A brightness enhancement structure according to claim 1 wherein the brightness enhancement structure comprises a unitary structure.

15. A brightness enhancement structure according to claim 1 wherein the array of optical microstructures is separated from the array of fresnel microstructures by a downstream gap of about 5.0 mm or less.

16. A rear-projection screen comprising:
a brightness enhancement structure configured to provide an elliptical light diffusion pattern with a major axis in a first screen dimension and a minor axis in a second screen dimension, that is orthogonal to the first screen dimension, to provide for transmission of light from the screen comprising a distribution pattern where a full-width-at-half maximum (FWHM) of the distribution pattern is located at +/− about 2 to about 30 degrees in the first screen dimension.

17. A rear-projection screen according to claim 16 wherein the brightness enhancement structure includes a diffusion material configured to diffuse light impinging thereon to provide diffused light downstream therefrom.

18. A rear-projection screen according to claim 16 wherein the brightness enhancement structure is free of a diffusion material.

19. A brightness enhancement structure comprising:
an array of compound microlenses including a first portion having a first index of refraction and a second portion, upstream from the first portion, having a second index of refraction at an interface with the first portion.

20. A brightness enhancement structure according to claim 19 wherein the compound microlenses comprise optical microstructures having the first index of refraction and a cladding layer thereon having the second index of refraction that is different than the first index of refraction.

21. A brightness enhancement structure according to claim 21 wherein the first index of refraction is about 1.5 and the second index of refraction is about 1.4 or less.

22. A brightness enhancement structure according to claim 21 wherein the first index of refraction is about 1.4 or less and the second index of refraction is about 1.5 or more.

23. A brightness enhancement structure according to claim 20 wherein the second index of refraction is a substantially constant throughout a thickness of the cladding layer.

24. A brightness enhancement structure according to claim 20 wherein the cladding layer includes a diffusion material configured to diffuse light impinging thereon to provide diffused light to the array of optical microstructures.

25. A brightness enhancement structure according to claim 20 wherein the cladding layer is free of a diffusion material.

26. A brightness enhancement structure comprising:
a lens weakening layer, on an array of optical microlenses, the lens weakening layer configured to provide a divergence angle of light from the structure that is less than the array of optical microlenses alone.

27. A brightness enhancement structure according to claim 26 wherein the lens weakening layer comprises a first index of refraction of about 1.4 or less at an interface with the optical microlenses and the optical microlenses comprise an index of refraction of about 1.5.

28. A brightness enhancement structure according to claim 26 wherein the first index of refraction is substantially constant throughout a thickness of the lens weakening layer.

29. A brightness enhancement structure according to claim 26 wherein the lens weakening layer includes a diffusion material configured to diffuse light impinging thereon to provide diffused light to the array of optical microlenses.

30. A brightness enhancement structure according to claim 26 wherein the lens weakening layer is free of a diffusion material.

31. A brightness enhancement structure comprising:
an array of compound microlenses having two separate refractive indexes, the array being on a first side of a substrate; and
fresnel microlenses on a second side of the substrate opposite the array of compound microlenses.

32. A brightness enhancement structure according to claim 31 wherein the compound microlenses comprise a first portion with a first index of refraction of about 1.4 or less at an interface with a second portion of the compound microlenses having an index of refraction of about 1.5.

33. A brightness enhancement structure according to claim 32 wherein the first index of refraction is substantially constant throughout a thickness of the first portion.

34. A brightness enhancement structure according to claim 31 wherein the compound microlenses includes a diffusion material configured to diffuse light impinging thereon to provide diffused light therefrom.

35. A brightness enhancement structure according to claim 31 wherein the compound microlenses are free of a diffusion material.

36. A brightness enhancement structure according to claim 31 wherein the array of optical microstructures is separated from the fresnel microlenses by a downstream gap of about 5.0 mm or less.

37. A rear-projection screen comprising:
a brightness enhancement structure comprising:
a substrate, configured for placement downstream from a light source, having a first side facing upstream and a second side facing downstream;
an array of first lenticular lenses on the first side of the substrate oriented in a first dimension of the screen;
a cladding layer on the array of first lenticular lenses; and
an array of fresnel microstructures on the second side of the substrate opposite the array of first lenticular lenses; and
an array of second lenticular lenses, orthogonal to the first lenticular lenses, downstream from the brightness enhancement structure.

38. A rear-projection screen according to claim 37 wherein first dimension of the screen comprises a vertical or horizontal screen dimension and the second dimension of the screen comprises a vertical or horizontal screen dimension.

39. A rear-projection screen according to claim 37 wherein the screen provides for transmission of light comprising a distribution pattern where a full-width-at-half maximum (FWHM) of the distribution pattern is located at +/− about 2 to about 30 degrees in the second dimension.

40. A method of fabricating a brightness enhancement film for a rear-projection screen, the method comprising:
forming an array of optical microstructures on a first side of a substrate;
flowing a cladding material between the array of optical microstructures and a planar sheet opposite the substrate;
curing the cladding material; and
forming fresnel microstructures on a second side of the substrate opposite the first side.

41. A method according to claim 40 wherein the cladding material comprises siloxane-containing polymers, fluoropolymers, perfluoropolymers, siloxane-containing fluoropolymers, siloxane-containing perfluoroacrylate polymers and/or siloxane-containing copolymers to provide the cladding layer with an index of refraction or about 1.4 or less.

42. A method according to claim 40 wherein the cladding material comprises a room temperature-vulcanizing silicone.

43. A method according to claim 40 wherein the cladding material comprises a liquid precursor material including a diffusion material suspended therein having a size of about 50 microns or less.

44. A method according to claim 43 wherein the diffusion material comprises silica, alumina, and/or polymeric material.

45. A method of operating a rear-projection screen comprising:
receiving light from a light source;
refracting the received light in a first screen dimension according to a first refractive index to provide first refracted light;
refracting the first refracted light in the first screen dimension according to a second refractive index to provide second refracted light;
refracting the second refracted light to provide an elliptical diffusion pattern with a major axis in the first screen dimension; and
refracting the second refracted light in the elliptical diffusion pattern to provides for transmission of light from the screen according to a distribution pattern where a full-width-at-half maximum (FWHM) of the distribution pattern is located at +/− about 2 to about 30 degrees in the first screen dimension.
